(19) United States
(12) Patent Application Publication
(10) Pub. No.: US 2024/0303634 A1
(43) Pub. Date: Sep. 12, 2024

(54) Interactive Artificial Intelligence System For Blockchain Transactions

(71) Applicant: Vladimir Djukic, Berane (ME)

(72) Inventor: Vladimir Djukic, Berane (ME)

(21) Appl. No.: 18/182,325

(22) Filed: Mar. 11, 2023

(51) Int. Cl. G06Q 20/36; G06Q 20/38; G06Q 20/40

(52) U.S. Cl. CPC G06Q 20/3674; G06Q 20/389; G06Q 20/4014

(57) ABSTRACT

The current invention offers an interactive artificial intelligence system that enables users to initiate blockchain transactions using communication devices while also assisting them in comprehending code with greater ease. The system includes portable computing devices that interact with messaging systems using device identification numbers or telephony-based or related identifiers, servers, networks, blockchain transaction effectors, blockchain transaction systems, and a natural language understanding unit (NLU) based on deep neural networks or representational learning. The NLU is equipped with a knowledge base to provide high confidence in interpreting and acting on blockchain transactions such as initiating transactions on the blockchain, generating receipts, payment details, and tracking transactions, among others. The communication interface features a predictive menu that utilizes the AI tool to predict the user's intended actions and displays them as a menu for selection, thus facilitating the transaction process.

### FIELD OF INVENTION

The field of invention for the described system is in the domain of artificial intelligence and blockchain technology, specifically the use of natural language understanding to initiate blockchain transactions through communication devices.

### BACKGROUND ART

Technology has been advancing at a remarkable pace across various sectors, including communication and information technology systems. These changes have the potential to transform many industries, and the field of blockchain technology is no exception. The introduction of Artificial Intelligence (AI) has the potential to revolutionize blockchain technology and the way transactions are carried out. AI tools can learn, optimize, and carry out complex tasks to speed up service delivery, improve operational efficiency, and increase access to solutions.

The present invention is focused on the development of an interactive artificial intelligence system for initiating blockchain transactions through communication devices. This system offers an efficient and practical solution that simplifies complex processes into intuitive and easy-to-use tools for blockchain transactions. AI-based systems are expected to automate various processes within the blockchain industry, including transaction effectors and payment service providers.

In the future, artificial intelligence is likely to automate facility management within the blockchain industry, enabling more efficient and cost-effective management of blockchain networks. It could also help to organize and analyze big data in the blockchain sector.

Currently, AI is being used for information management, where it collects data on blockchain transactions and analyzes it in real-time. The AI-based system is designed to enhance the efficiency of blockchain entities, including blockchain users, transaction service providers, and blockchain systems. The AI tools can also carry out analysis functions in the areas of energy, fire protection, and security to automate conventional blockchain facilities such as monitoring and control systems.

Overall, AI-based systems are poised to shape the future of blockchain technology for many years to come. The ability to collect, analyze, and learn from a large inflow of data promises to make transactions more efficient and effective, ultimately empowering users to carry out transactions with much less uncertainty.

The following prior art documents are relevant and may be claimed as benefit by the present invention. These documents describe various systems and methods related to speech recognition, natural language understanding, and smart searches, which can contribute to the development of the present invention. Each of these documents has introduced unique features and techniques that can enhance the efficiency and effectiveness of the proposed interactive artificial intelligence system for blockchain transactions. By building on the knowledge and insights provided in these documents, the present invention can provide a better user experience, improve task accomplishment, and streamline the blockchain transaction process.

EP3230979B1: The prior art invention discloses a dialogue belief tracking system that allows a device to engage in human-like conversation with a user over multiple turns. The system determines one or more user goals and performs actions based on them, which enables the user to accomplish tasks and obtain desired products/services without explicitly stating each intent and desired goal.

EP3314606B1: Another prior art invention is an automatic speech recognition (ASR) system that detects the endpoint of an utterance by calculating the amount of non-speech detected by a plurality of hypotheses and weighting the non-speech duration by the probability of each hypothesis. If the aggregate weighted non-speech exceeds a threshold, an endpoint may be declared.

EP2973002B1: This prior art invention relates to a method for inferring user intent based on a speech input in a first language, generating alternative expressions of the first speech input based on the inferred user intent, and providing feedback to the user introducing the alternative expressions as a more preferred input to express the inferred user intent.

EP3268697B1: The prior art invention is an architecture that enables smart searches along a route based on the time to entities along and off the route. It includes a user experience that showcases rich entities along the route, saving, sharing, and editing capabilities across devices and users, smart ranking and filtering of entities, and user preferences and digital personal assistant interaction.

Unlike the prior art documents described, the invention's use of blockchain technology and AI tools in combination provides a faster, more efficient, and streamlined approach to initiating and tracking transactions on the blockchain.

### SUMMARY OF THE INVENTION

The following summary is an explanation of some of the general inventive steps for the system, method, devices and devices in the description. This summary is not an extensive overview of the invention and does not intend to limit its scope beyond this summary.

In summary, the present invention relates to a communication device comprising a communication program that can communicate with a server via a network to transmit messages between the device and the server. In this communication system, messages are identifiable to the communicating device, and the recipient is identified in the message transmission. The recipient of the message in the described communication system is a Natural Language Understanding (NLU) based blockchain transaction processing system. This system is designed to receive messages from communication devices, identify the intent of the message and extract any relevant variables.

The message is passed to a Natural Language Understanding (NLU) unit to extract an intent, which is the desired action or task that the user wants to perform. The NLU unit also extracts variables, which are specific pieces of information required to perform the intended action. Once the intent and variables are extracted, the system initiates a blockchain-based transaction to perform the requested action, such as swapping currencies, sending currency from an account or wallet, or trading currencies in the blockchain.

For example, if the user wants to swap currencies, the communication program will instruct the blockchain-based transaction system to perform the currency swap. If the user wants to send currency from an account or wallet in the blockchain system, the communication program will identify the specific account or wallet and initiate the transfer. If the user wants to trade currencies in the blockchain, the communication program will execute the trade.

The blockchain transaction is initiated by communicating with the blockchain system using the communication program. The communication program sends a request to the blockchain system, which then processes the request and performs the requested transaction. Once the blockchain system has completed the transaction, the result of the transaction is transmitted back to the communicating device in complete clarity. The user receives a clear and concise message confirming that the requested action has been completed, along with any relevant details, such as transaction ID, amount sent, and current exchange rates. This ensures that the user has a complete understanding of the transaction and can easily track its progress.

In one aspect, the NLU system is trained to understand natural language commands and to extract relevant information from them. It uses advanced algorithms and machine learning techniques to accurately identify the intent of the message and to extract any variables that are required to perform the requested action. This allows users to communicate with the blockchain system in a natural and intuitive way, without having to learn complex commands or syntax.

In one aspect, the system can have a predictive interface by using machine learning algorithms to analyze user data and behavior to make predictions on the user's next actions or intentions. The system can collect and analyze data such as previous transactions, user preferences, browsing history, and other relevant data to make accurate predictions on what the user may want to do next. The predictive interface can provide personalized suggestions to the user, such as recommending specific products or services, predicting the amount of money to be sent in a transaction, or even predicting the likelihood of a fraudulent transaction. This can save time for the user and provide a more efficient and personalized experience.

In some aspect, the predictive interface can adapt and improve over time as the system collects more data and learns from user behavior. This can lead to more accurate predictions and better user experience.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 depicts a transactional artificial intelligence system 100, comprising of portable computing devices, servers, networks, blockchain transaction system, messaging system and a natural language understanding unit.

FIG. 2 depicts the architecture and layout of the artificial intelligence tools as interfaced with a messaging system, portable computing devices with communication interfaces, and blockchain transaction effector modules

FIG. 3 shows a process of intent and entity extraction for carrying out by the effector for blockchain transactions.

FIG. 4 illustrates the process of initiating and executing payment transaction instructions on a blockchain

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

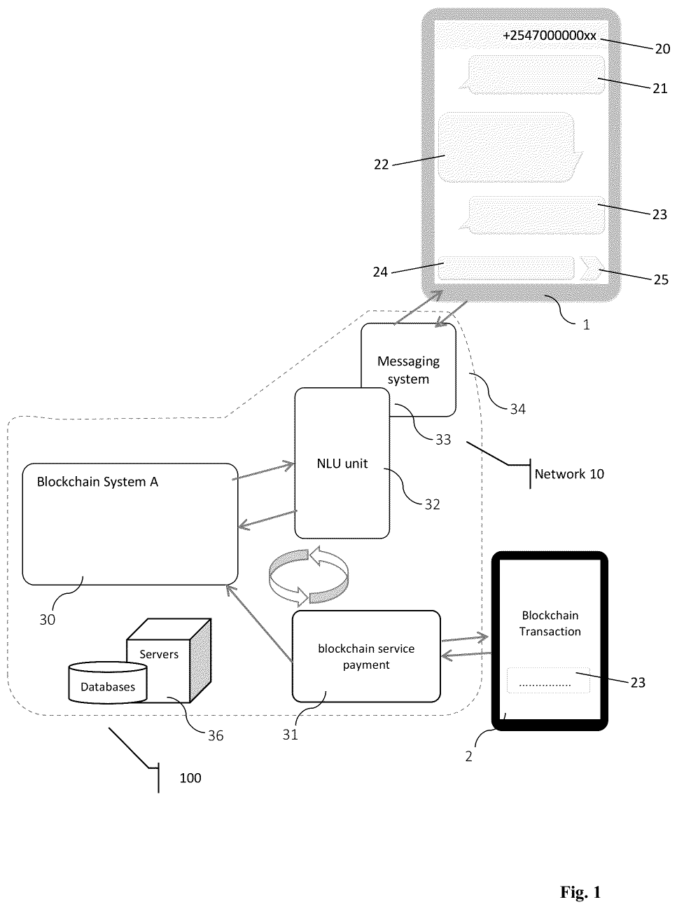

The FIG. 1 describes a first embodiment of the current invention, the devices, modules and elements constituting a system 100. They comprise of portable computing devices such as 1 & 2, servers and databases 36, a network 10, an internal network 34, a blockchain based transaction service or payment service provider 31, a messaging systems 33, a natural language understanding unit (NLU) 32 and a blockchain based transaction system 30. Any such computing device configured as a bank or payment service provider 31 constitutes a transacting tool.

The portable computing device 1 has a graphical user interface 10. It is configured as a communication terminal, which can perform messages interchange between itself and a messaging system 34 that uses device identifier, email, username, telephone number based identifications or any such identifiers (collectively device identifiers) that are assigned to communication terminals. The elements of communication configured on the terminal include the device identifier such as the telephone number based identification number 20 herewith referred to as the communication terminal identifier (the terminal identifier or device identifier could further be any unique identifiers that can be assigned to both a communication terminal and a blockchain transaction system user), a first message 21 from a user of the communication terminal, a first response 22 by the natural language understanding unit 32 (or artificial intelligence module), a second message 23 from a user of the tool, a message input enabler 24, with the message being either audio, video, image or text, and a transmission enabler 25.

When operated, the communication terminal 1 transmits a message and its identifier via a network to a second module/device/platform/system 33 embodying a computing device or devices configured as a messaging system, herewith referred to as a messaging system or terminal. For example, a message could be in natural language in any language such as:
“Pls, send 1 Bitcoin to Vlad”
“Enter 2fa pin”
“Transaction receipt”

In turn, the second terminal 33 transmits the message to the NLU 32, which constitutes at least a context handler, a knowledge base, natural language processing unit, a decision helper and an effector. Once in the NLU, the communication terminal or device identifier is extracted in context of the message, and such a message is passed through a natural language processor to derive meaning, and then through the knowledge base to infer intent or intents, and finally, an intent is chosen based on highest probability by a decision helper. The inferred intent and the communication terminal/device identifier are then passed to an effector, which uses the communication terminal identifier further as an identifier of a wallet or account in a blockchain based transaction system. Once a response is derived from the effector, the context handler is configured to pass the response as a message to the messaging system or terminal 33 with the recipient identified by the communication device/terminal identifier. A message is thus received by the communication terminal 1.

In some aspect, there may be an additional payment authentication process. In such an implementation, where the effector was acting out on a payment intent, the authentication may prompted on the communication terminal for transaction authorization. This prompt may be in the form of a PIN request, an authorization request, an OTP or any such.

In some aspect, an internal network 10 is depicted allowing the data communication between the elements 30, 31, 32 and 33 of the system. This network may be constituted of any such medium for transmitting packets of data between any number of computing devices or software modules including but not limited to Wi-Fi, LAN, Bus bar, cables, fibre optic cables, 5G, 6G, mobile broadband among others.

In some aspect, there may be a blockchain based transaction service or payment service provider 31 that is operably coupled with the device 2 with a graphical user interface 23 adapted to operate the execution of blockchain transactions.

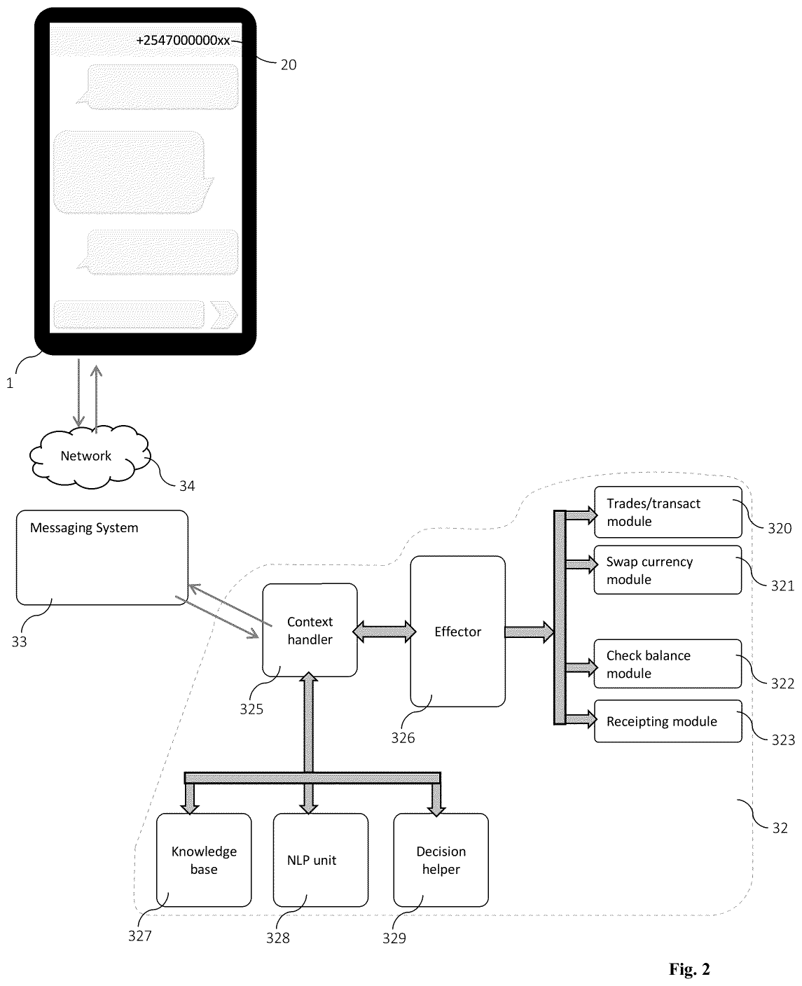

The exemplary embodiment according to FIG. 2 of the drawings illustrates the natural language understanding unit or module 32 according to one aspect of the current invention, coupled with or in data communication with the messaging system 33 and a communication terminal 1 within a network 34. The natural language understanding unit 32 is comprises of a context handler 325, knowledge base 327, natural language processing unit 328 (327 and 328 jointly constituting a an intent discovery module) decision helper 329 and an effector 326. Any such computing device configured with the natural language understanding unit 32 constitutes an artificial intelligence module (or terminal), and the two may be used interchangeably. Any such computing device configured with the messaging system 33 constitutes a messaging system (or tool), and the two may be used interchangeably in these descriptions.

When operated, the communication terminal 1 transmits a message to a messaging system 33 via a network 34, with a defined recipient being an identified user of the messaging terminal. The message transmitted by the communication terminal is identified with a unique identifier 20, such as but not limited to a device ID, a telephone number, with the recipient being an equally unique identifier. The messaging terminal is configured to be capable to transmit the messages sent to a certain recipient with a unique identifier to the artificial intelligence system (herein sometimes referred to alternatively as natural language understanding unit) 32.

At the natural language understanding unit 32, a context handler 325 first separates the sender's device identifier (or its representation) 20 from the message. The message is passed through a natural language processor (NLP) 328 to derive the meaning in any specified standard or language and any other parameters. Such a message whose meaning has been derived or the derived meaning is then passed through a knowledge base 327 to determine any number of intent probabilities. Finally, the intent probabilities are passed through a decision helper 329, wherein the most probable intent is selected. The selected intent is thereafter relayed to the context handler, where it is merged with the sender's device identifier number (or its representation).

A natural language processor (NLP) 328 in the context of this invention comprises any such implement or methods of transforming natural language or preconfigured-selections into a format or values that are understandable and in some cases, previously known to a natural language understanding unit. Such a format or value is what is herein referred to as meaning. Further still, the knowledge base 327 in the context of this invention constitutes an aggregation of intents and how users can phrase them.

In some aspect, the effector 326 would be responsible for executing the actions based on the intent and variables extracted by the NLU system. For example, if the intent was to swap currencies in a blockchain-based transaction system and the variables included the currencies to be swapped and the exchange rate, the effector would be responsible for carrying out the actual transaction. The effector could be a software program or a physical device, depending on the specific implementation of the system. Its main function is to act upon the information extracted by the NLU system and carry out the desired actions in the blockchain transaction system. The effector 326 may comprise several modules to effect various aspects of blockchain transactions shown as a trading and/or transacting module 320, a currency swap module 321, a check balance module 322, and a receipting module 323.

The trading and/or transacting module 320 may be configured to execute transactions on the blockchain, such as buying and selling cryptocurrency. Specifically, if the intent extracted from the message is to trade currencies, this module is responsible for executing the trade transaction. Once the intent is identified, the NLU unit extracts the necessary variables from the message, such as the currency type, amount, and destination wallet address, among others. The trading and/or transacting module 320 receives these variables and executes the trade transaction on the blockchain system, where it swaps the specified currency with another currency in the specified amount at the current market rate.

The trading and/or transacting module 320 may also check the balance of the account or wallet from which the trade transaction is to be executed using the check balance module 322 to ensure that there are sufficient funds available to complete the transaction. If there are not enough funds, the module may return an error message to the sender communication device indicating that the transaction cannot be completed due to insufficient funds.

In one aspect, once the trade transaction is executed, the receipting module 323 may generate a receipt that includes details of the transaction, such as the currency type, amount, destination wallet address, transaction fee, and other pertinent details. This receipt is then transmitted back to the sender communication device, providing complete clarity and transparency of the transaction.

The currency swap module 321 may be configured to swap one type of cryptocurrency for another type of cryptocurrency. Specifically, the module is designed to facilitate the exchange of one type of cryptocurrency or digital asset for another, based on the intent extracted by the NLU unit. The communication device may transmit a message with an identified intent to the NLU-based blockchain transaction processing system via the communication program, along with the necessary details of the transaction such as the currencies involved, the exchange rate, and the amounts to be exchanged.

The NLU unit may then extract the intent and necessary variables, including the source and destination cryptocurrencies, and send this information to the effector module 326, specifically the currency swap module 321. This module would then carry out the currency swap transaction on the blockchain, exchanging the specified amount of the source cryptocurrency for the specified amount of the destination cryptocurrency at the prevailing exchange rate. The currency swap module 321 would ensure that the transaction is executed securely and efficiently on the blockchain, while also providing real-time feedback to the communication device via the communication program.

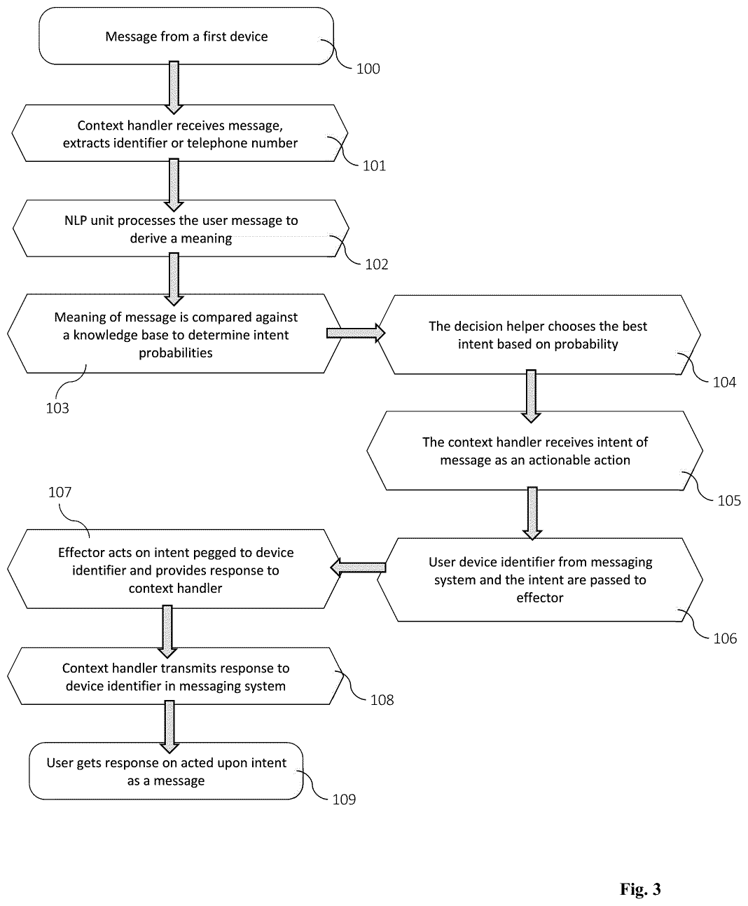

According to one aspect, FIG. 3 describes the process of inferring to an intent from a message and the subsequent method of acting on it within the context of the current invention. It begins with transmitting a message spoken, image or text from a communication terminal as in 100 to a recipient via a messaging system, wherein such a message is transmitted to an artificial intelligence module 32. Next, the context handler of the artificial intelligence module extracts the device identifier or telephone number (or related value) from the message and holds the identifier in context of the message as in 101. The message is passed to the natural language processing unit to derive meaning, illustrating step 102. In step 103 the meaning of the message is compared against a knowledge base of intents to determine intent probabilities. In some cases, the steps 103 and 102 may be carried out simultaneously, wherein, the message is compared directly to the knowledge base, to infer to intent probabilities.

Subsequently, a decision helper as in 104 chooses the best intent based on probability, typically choosing the intent with the highest probability. Next, the context handler receives the inferred intent in the context of the previously extracted telephone number (or related value) in step 105. Next, the extracted identifier (or related value) and the intent are passed to the effector for action in 106. At the effector in step 107, the intent is acted upon, with the identifier derived from the communication device (or related value) being the unique value attached to the action of the effector, such as when executing a blockchain transaction, and a response is passed to the context handler, in context of the identifier (or related value). In step 108, the context handler transmits the response to the messaging system with the recipient being identified with the extracted device identifier (or related value). Finally, a message response is received by the communication device as acted upon intent as a message.

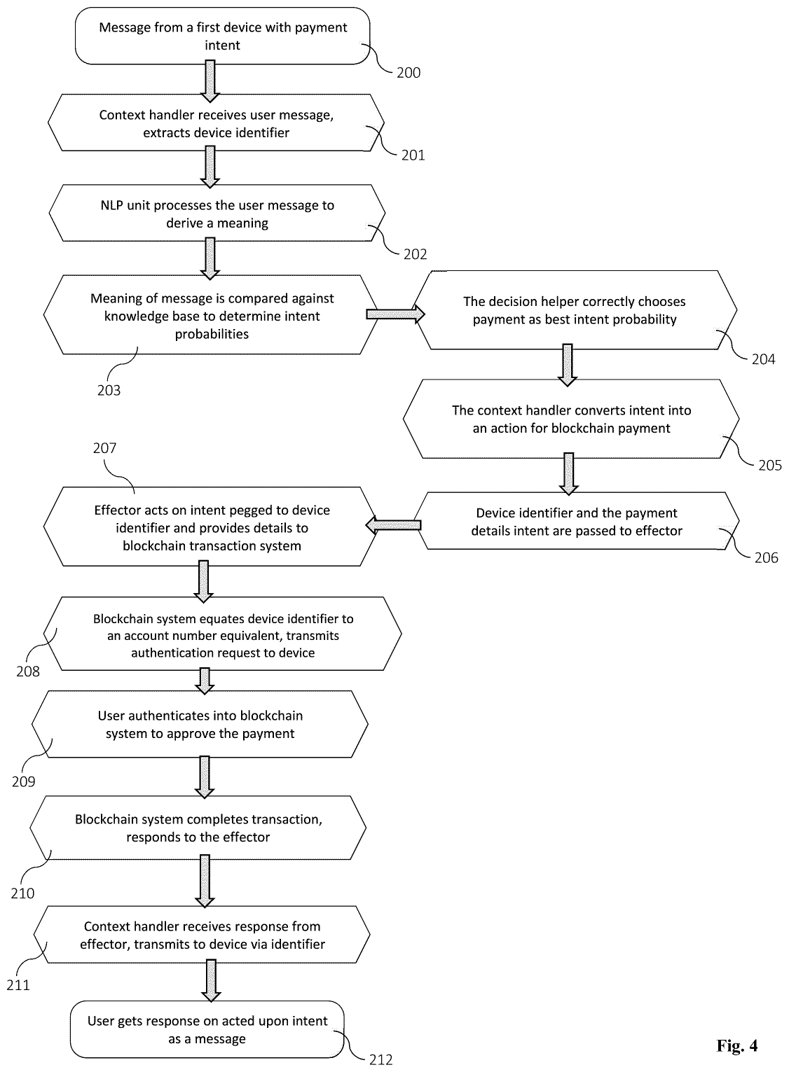

Now referring to the FIG. 4, it is described the process of inferring to a blockchain transaction or payment (or currency swap) intent from a message and the subsequent method of acting on it within the context of the current invention. It begins with transmitting a message spoken, image or text with a payment intent from a communication terminal/device as in 200 to a recipient via a messaging terminal, wherein a message sent to such a recipient is transmitted to an artificial intelligence module 32. Next, the context handler of the artificial intelligence tool extracts the transmitting device's identifier (or related value) from the message and holds the identifier in context of the message as in 201. The message is passed to the natural language processing unit to derive meaning, illustrating step 202. In step 203 the meaning of the message is compared against a knowledge base of intents to determine intent probabilities. In some cases, the steps 202 and 203 may be carried out simultaneously, wherein, the message is compared directly to the knowledge base, to infer to intent probabilities.

Subsequently, a decision helper as in 204 correctly chooses the blockchain transaction variables and the intent based on probability. Next, the context handler receives the inferred intent in the context of the previously extracted identifier (or related value) in step 205 for action. Next, the extracted identifier (or related value) and the blockchain transaction intent are passed to the effector for action in 206. In 207, the effector acts on intent pegged to the intent identifier and provides the intent and transaction variable to the blockchain transaction system.

Next, the blockchain system equates device identifier to an account number, wallet or equivalent and may in some cases transmit authentication request to device in anticipation of an authorization code as in 208, with such a message being received by the communication device 1. In step 209, a user may authenticate into blockchain system to approve the payment by provided necessary authentication via their communication device/terminal.

In step 210, the blockchain system may completes transaction, and respond to the effector. If successful, the blockchain transaction system may transmit the data of successful transaction to be received by the effector and further to the context handler. In 211, the context handler receives a response from effector, transmits to user device in the messaging system by virtues of the extracted identifier (or related value). Finally, in 216, the user gets a response on acted upon intent as a message completing the blockchain transaction.

According to one aspect, a user can input a specific command or keyword that triggers a response from the system to provide information on how the code functions behind the scenes. For example, the user could input the command “show code” or “code explanation” to request an explanation of how the code works. The system could respond with a message that provides a high-level overview of the code structure and functions, or it could provide a more detailed response that walks the user through specific sections of the code. Additionally, the system could offer visual aids such as diagrams or flowcharts to help the user understand the code's inner workings.

In another aspect, if a user is not familiar with code, the chat interface can provide a step-by-step explanation of how the system works in simple and easy-to-understand language. For example, the system can use natural language processing to interpret the user's questions and respond with clear explanations of the underlying code and processes. To start, the chat interface can provide an introduction to the system, describing its purpose and how it works in broad terms. From there, the user can ask specific questions about the system's functionality, such as how it processes user input, how it makes decisions about blockchain transactions, and how it communicates with the blockchain network.

Further, the chat interface can respond to these questions by providing detailed explanations of the underlying code and processes, using analogies and examples that the user can understand. The interface can also provide visual aids, such as diagrams and flowcharts, to help the user visualize how the system works.

One embodiment of the chat response feature described above involves integrating a “guardian” chatbot within the user interface of a token platform. The chatbot is designed to act as a guide for users who want to learn more about the code behind a specific token.

For instance, when a user initiates a chat with the guardian, the chatbot can first ask the user which token they are interested in learning about. Once the user has identified the token, the chatbot can provide a summary of the token's purpose and functionality.

The chatbot can then provide an overview of the code behind the token, breaking it down into simpler terms and explaining how the code works. The chatbot can use diagrams, animations, and other interactive tools to help explain the code in a way that is more accessible to users.

Additionally, the chatbot can answer any questions the user has about the code or the token in general. This can help users gain a better understanding of the token's functionality and how it can be used in different scenarios. To further enhance the user experience, the chatbot can also provide links to external resources, such as tutorials or articles, that provide more in-depth information about the code and token.

In order to achieve this, the system can interact with blockchain explorers to obtain the source code of the token. The source code is then analyzed to extract relevant codes and functions, which are then fed into a natural language understanding (NLU) module. Users can then ask questions about the source code as a whole or about specific functions. By allowing users to interact with the code behind a token, they can gain a better understanding of how the token works and what it's designed to do. This can help users gain confidence in the token and feel more secure in using it.

Below is a sample conversation based on one embodiment of the guardian chatbot:
User: Can I customize these fees?
NLU: No, the fees are fixed and cannot be customized.
User: Is there any minimum or maximum limit for the transfer amount? NLU: Yes, there is a minimum limit of 0.1 token and a maximum limit of 10,000 tokens per transfer.
User: Can this function be called by anyone or is there any permission required?
NLU: This function can be called by anyone who holds the token, but the transaction will require the user's private key for authentication.
User: Can I add any additional data while transferring tokens? NLU: Yes, you can add additional data to the transaction in the form of a message up to 256 characters long.
User: Can I track the transaction status after I initiate a transfer using this function?
AI: Yes, you can track the transaction status by using the transaction ID generated by the function. The status can be tracked using a blockchain explorer.

The objective of such an embodiment is to provide users with a more user-friendly and accessible way to understand the underlying code behind a token without the need for any coding knowledge. With this, users can chat with a “guardian” to get information about the code behind a token just by chatting.

By providing users with a more accessible way to learn about the code behind a token, this embodiment can help increase user confidence and trust in the token. This can ultimately lead to greater adoption and usage of the token, as users feel more informed and secure in their decision to use it.

It is anticipated that some embodiments of the disclosed invention may be a system, a method, and/or a computer program product at any possible technical detail level of integration. The computer program product may include a computer readable storage medium (or media) having computer readable program instructions thereon for causing a processor to carry out aspects of the present invention.

It is anticipated that blocks in flowchart illustrations and/or block diagrams, and combinations of blocks in the flowchart illustrations and/or block diagrams, can be implemented by computer readable program instructions.

It is further anticipated that where computer readable program instructions are provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. As such, computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

Accordingly, the applicant intends to embrace all such alternatives, modifications, equivalents and variations that are within the spirit and scope of the disclosed subject matter. It should also be understood that references to items in the singular should be understood to include items in the plural, and vice versa, unless explicitly stated otherwise or clearly from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

### INDUSTRIAL APPLICATION

The industrial application of the invention could be in the financial technology industry. Specifically, the invention could be applied in the blockchain-based financial transactions sector, such as cryptocurrency trading, foreign exchange transactions, and other digital asset transfers. The invention could be used to improve the efficiency and convenience of these transactions, while also ensuring their security and accuracy.

The invention could also be applied in other industries that require secure and efficient data transmission, such as healthcare, logistics, and supply chain management.

What is claimed is:

1. A system for inferring intent and executing blockchain transactions, comprising:
a messaging system configured to receive messages from communication terminals/devices, the message comprising a payment intent and variables executable by a blockchain;
an artificial intelligence module comprising a natural language processing unit, a decision helper, and an effector, the module being capable of deriving meaning from the message using natural language processing, inferring the blockchain transaction intent based on probability, and associating the inferred intent with the extracted device identifier or related value;
a blockchain transaction system;
a context handler configured to extract device identifiers from the messages and hold them in context of the messages; and
a communication device/terminal capable of initiating the message comprising a payment intent and variables executable by a blockchain.

2. The system of claim 1, wherein the natural language processing unit is configured to derive meaning from the messages and compare the meaning against a knowledge base of intents to determine intent probabilities.

3. The system of claim 2, wherein the decision helper is configured to choose the best intent based on probability, and the context handler is configured to receive the inferred intent in the context of the extracted device identifier.

4. The system of claim 3, wherein the effector is configured to act on the inferred intent with the extracted device identifier or telephone number, and the communication device/terminal is configured to receive the response in context of the extracted device identifier or telephone number.

5. The system of claim 4, wherein the blockchain transaction system is configured to equate the device identifier or telephone number to an account number or wallet, and authenticate the user for approval of the payment.

6. The system of claim 5, wherein the context handler is further configured to receive the response from the effector, transmit the response to the messaging system, and receive a message response on the acted upon intent as a message from the user communication device/terminal.

7. The system of claim 1, wherein the communication device/terminal is a mobile device or computer.

8. A non-transitory computer-readable medium comprising a computer program product for inferring intent and executing blockchain transactions, the computer program product comprising:
a natural language processing unit;
a decision helper;
an effector;
a blockchain transaction system;
a context handler;
instructions for extracting device identifiers or telephone numbers from the messages and holding them in context of the messages; and
instructions for comparing the meaning of the messages against a knowledge base of intents to determine intent probabilities.

9. The non-transitory computer-readable medium of claim 8, further comprising instructions for choosing the best intent based on probability, and instructions for receiving the inferred intent in the context of the extracted device identifier or telephone number.

10. The non-transitory computer-readable medium of claim 9, further comprising instructions for acting on the inferred intent with the extracted device identifier or telephone number, and instructions for receiving the response in context of the extracted device identifier or telephone number.

11. The non-transitory computer-readable medium of claim 10, further comprising instructions for equating the device identifier or telephone number to an account number or wallet, and authenticating the user for approval of the payment.

12. The non-transitory computer-readable medium of claim 11, further comprising instructions for receiving the response from the effector, transmitting the response to the messaging system, and receiving a message response on the acted upon intent as a message from the user communication device/terminal.

13. The non-transitory computer-readable medium of claim 8, wherein the communication device/terminal is a mobile device or computer.

14. A method for inferring intent and executing blockchain transactions, comprising:
receiving a message comprising a payment intent from a communication terminal;
extracting a device identifier or related value from the message;
deriving meaning from the message using natural language processing;
comparing the derived meaning against a knowledge base of intents to determine intent probabilities;
inferring the best intent based on probability;
associating the inferred intent with the extracted device identifier or related value;
passing the inferred intent and extracted identifier to an effector for action;
acting on the intent using the effector, with the extracted identifier or related value being a unique value attached to the action of the effector; and
providing a response to the context handler, in context of the identifier or related value.

15. The method of claim 14, wherein the payment intent comprises a blockchain transaction.

16. The method of claim 14, wherein the payment intent comprises a payment or currency swap.

17. The method of claim 14, further comprising transmitting a message response to the messaging system with the recipient being identified with the extracted device identifier or related value.

18. The method of claim 14, further comprising authenticating a user into the blockchain system to approve the payment by providing necessary authentication via their communication device/terminal.

19. The method of claim 14, wherein the effector acts on the intent by providing the intent and transaction variable to the blockchain transaction system.

20. The method of claim 14, wherein the blockchain system transmits an authentication request to the device in anticipation of an authorization code.

21. The method of claim 14, wherein the context handler receives a response from the effector and transmits the response to the messaging system with the recipient being identified with the extracted device identifier or related value.

22. A method for providing users with an interactive interface to understand the code behind a token, comprising:
extracting codes and functions from the source code of the token using blockchain explorers;
feeding the extracted codes and functions into a natural language understanding (NLU) module; and
allowing users to interact with the NLU module via a chat interface to gain information about the code behind the token.

23. The method of claim 22, further comprising providing users with a list of available functions within the token's source code.

24. The method of claim 22, further comprising allowing users to ask questions about individual functions within the token's source code.

25. The method of claim 22, further comprising providing users with information about fees and charges associated with individual functions within the token's source code.
